(19) United States
(12) Patent Application Publication
(10) Pub. No.: US 2017/0030372 A1
(43) Pub. Date: Feb. 2, 2017

(54) FLUID-TRANSFER DEVICE AND METHOD FOR MANUFACTURING SAME

(71) Applicant: AIRBUS SAFRAN LAUNCHERS SAS, Issy les Moulineaux (FR)

(72) Inventors: Sebastien BOUFFLERT, Louviers (FR); Philippe BOURDIN, Saint-Just (FR); Fabien TESSIER, Vernon (FR); Vincent LANGLOIS, La Haye-Malherbe (FR)

(73) Assignee: AIRBUS SAFRAN LAUNCHERS SAS, Issy les Moulineaux (FR)

(21) Appl. No.: 15/303,108

(22) PCT Filed: Apr. 8, 2015
(86) PCT No.: PCT/FR2015/050916

§ 371 Date: Oct. 10, 2016

(30) Foreign Application Priority Data
Apr. 10, 2014 (FR) 1453193

(51) Int. Cl. F04D 29/44; B23H 7/38; F04D 1/06

(52) U.S. Cl. CPC F04D 29/441; F04D 1/06; F04D 29/444; B23H 7/38

(57) ABSTRACT

A fluid transfer device including a rotor having two centrifugal wheels, and a stator incorporating a set of continuous axi symmetric return channels conveying the fluid from the first wheel to the second wheel. Each of the return channels includes in succession a diffusing portion that guides the fluid in a centrifugal direction, a bend portion that redirects the fluid stream in a centripetal direction, a return portion that guides the fluid along a centripetal path, and then an outlet portion formed in a first non-tubular part that guides the fluid towards the second wheel. In these channels, the diffusing portion and the bend portion are distinct parts, and the diffusing portion is formed in a second non-tubular part secured to the first non-tubular part. A method of fabricating the device.

The invention relates to a fluid transfer device comprising a rotor having at least a first centrifugal wheel and a second centrifugal wheel, and a stator incorporating a plurality of return channels; in which device the return channels are axisymmetric, and each return channel comprises in succession along the fluid flow path from the first wheel:
a diffusing portion suitable for guiding the fluid stream in a centrifugal flow direction; then
a bend portion suitable for redirecting the fluid stream in a centripetal flow direction; then
a return portion suitable for guiding the fluid along a centripetal path, and generally of substantially straight shape; and then
an outlet portion formed in a first non-tubular part, and suitable for guiding the fluid towards the inlet of the second centrifugal wheel.

The term “centrifugal wheel” is used to mean a bladed wheel having blades that are arranged in such a manner as to create an increase in pressure between the inlet and the outlet of the wheel when the wheel is driven in rotation at high speed and when it is fed with fluid. The “inlet” of the wheel is used herein to mean the set of admission orifices of the wheel through which the fluid penetrates between the blades of the wheel; the “outlet” of the wheel is used to mean the set of delivery orifices of the wheel.

In the return channels, the diffusing portion is the upstream portion of the channel, which guides the fluid in a direction that is substantially radial in projection onto a section plane containing the axis of rotation. The bend portion is the portion including a bend, serving to redirect the fluid stream from a centrifugal direction to a centripetal direction. A flow direction is said to be “centripetal” (or else “centrifugal”) when the flow direction of the fluid causes the fluid to come closer to (or else go further away from) the axis of rotation of the rotor, which direction may be perpendicular or oblique relative to the axis of rotation.

The return portion is a portion of the return channel that is generally substantially straight in shape, and in which the fluid stream is guided along a centripetal path from the bend portion to the outlet portion of each channel. The term “centripetal path” is used herein to mean that the path followed by the fluid causes the fluid to come closer to the axis of the rotor.

The outlet portion is the downstream portion of the channel, and it directs the fluid stream in such a manner as to enable it to enter into the second wheel with minimized head loss and while the fluid is travelling in a direction that is optimized for being injected into the inlet of the second wheel.

Channels that are “axisymmetric” are channels of identical shape, differing from one another in angular position about the axis of the device.

Such a device is disclosed by way of example in French patent application number FR 2 772 843.

The invention relates in particular to such devices that are used in turbomachines for cryogenic rocket engines, in which the turbomachine is a turbopump serving to feed the engine with liquid hydrogen or some other liquid.

The return channels pick up or collect the fluid flow leaving the first wheel at high speed so as to guide it, slow it down, and take it to the inlet of the second wheel. These return channels thus constitute one of the main elements of the architecture of the turbomachine (centrifugal pump or centrifugal compressor). Their arrangement determines the radial and axial size of the turbomachine.

The return channels present three-dimensional surfaces that are complex. Their shape needs to be carefully designed so as to minimize head losses, and to do so with a size that is as small as possible, both axially and radially. Nevertheless, the constraints of various fabrication methods sometimes make it difficult, if not impossible, to obtain certain shapes for the return channels.

As a result, it often happens that the shape of the return channels is not optimized, thereby leading to lower efficiency for the transfer device.

In an already known embodiment, the return channels are continuous: i.e. each of the return channels collects a portion of a fluid stream leaving an upstream wheel and directs this collected fluid stream to an inlet of a downstream wheel, and does so without exchanging fluid with the other return channels.

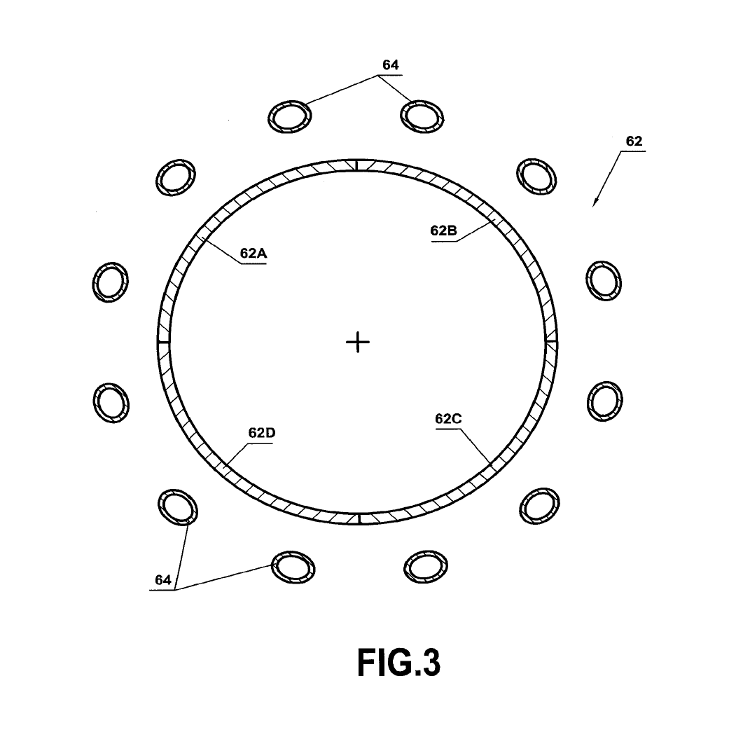

Nevertheless, the difficulties of making continuous return channels in a single part extending over 360° around the axis of rotation of the rotor have thus led to discontinuous return channels being envisaged, such as those shown in FIG. 3 of the above-mentioned document, in order to enable the parts to be made.

In the embodiment shown in the figure, the ducts making the connection between the outlet of the first centrifugal wheel and the inlet of the second centrifugal wheel are made up of three portions: a vaned radial diffuser; a non-vaned return bend; and then centripetal guide means made up of return vanes. In addition to the fact that that solution requires a radial diffuser that is large in order to limit losses of performance, the losses caused by the change in section at the outlet from the radial diffuser, followed by the losses caused by the return bend and by the angle of incidence on the guide means are difficult to control. This concept of return channels is thus found not to be optimum, whether from the point of view of radial size or from the point of view of performance.

This problem of performance has also been observed with return channels made in the form of “open” continuous channels. Herein, continuous channels are said to be “open” when continuous channels are obtained by connecting at least two external shells on an “internal” part in which the channels are made in advance (with the channels then extending from the outlet of the first wheel to the inlet of the second wheel). Because of discontinuities associated with assembly, those channels present performance that is relatively mediocre, and that can also deteriorate very significantly in the event of clearance between the external shells and the internal part.

Thus, a first object of the invention is to propose a fluid transfer device of the type described in the introduction that presents return channels of optimized shape, and consequently that presents efficiency that is improved compared with known devices.

A second object is to provide a fluid transfer device that remains relatively simple to fabricate.

These objects are achieved by the fact that each of said return channels is suitable for collecting a portion of a fluid stream leaving the first wheel and for directing this stream portion to an inlet of the second wheel without exchanging fluid with any other one of said return channels; and that for each of the channels, the diffusing portion and the bend portion are formed in parts that are distinct, and the diffusing portion is formed in a second non-tubular part that is secured to the first non-tubular part in which the above-mentioned outlet portion is formed.

Thereafter, as for each return channel, the diffusing portion and the bend portion are made in distinct parts, and the invention advantageously makes it possible to use different methods for making the parts containing these two return channel portions.

Specifically, these two return channel portions present constraints that are quite different: the diffusing portion is the portion in which the flow speed of the fluid is the fastest. It is therefore appropriate to give precedence to good surface state, so as to limit turbulence. Since the diffusing portion has a direction that is substantially radial in projection on a plane containing the axis of rotation, its shape remains relatively simple, thus making it possible to envisage numerous methods, in particular methods that are accurate and that provide parts having a good surface state, such as for example machining and electro-erosion.

Conversely, the bend part is characterized by its shape, which is complex, the presence of a bend giving rise to major fabrication constraints. The method of fabricating the part(s) including the bend portion may be specially selected to be suitable for making this shape.

Finally, in the device of the invention, arranging the channels within a plurality of parts, and using tubes (when this embodiment is selected) make it easier to inspect the channels during fabrication and perform quality control.

The fact that the first and second non-tubular parts are secured to each other means that they are rigidly connected together.

For this purpose, and in order to simplify the fluid transfer device, in one embodiment, for each of the return channels, the diffusing portion and the outlet portion are formed as a single non-tubular part.

A part is said herein to be “non-tubular” when the part has a passage formed therein and different portions of the passage present different wall thicknesses.

Conversely, a tube or a part is said to be “tubular” when the part has a passage formed therein and the walls of the passage present a thickness that is substantially constant over at least the majority of the part.

Non-tubular parts are generally mechanically very strong (where applicable, because of relatively large wall thicknesses), thus advantageously enabling them to be used for making structural parts of the turbomachine, i.e. parts that contribute to the overall mechanical strength of the turbomachine.

In general, non-tubular parts are formed by adding or removing material (e.g. by sintering powder or by casting followed by machining). A tubular part can optionally also be made by such methods, but can also be made by other methods, e.g. such as extrusion and hydroforming.

Making the diffusing portion and the outlet portion out of non-tubular parts enables the shape of those portions of the channels to be optimized, and thus makes it possible not only for the picking up and the slowing down of the fluid leaving the first centrifugal wheel to be optimized, but also for the guidance of the fluid into the second centrifugal wheel to be optimized.

Since the outlet portion is formed in a non-tubular part, it is easier to attach to the return portion, in particular when the return portion is tubular; furthermore, the first non-tubular part may have exactly the shape that is appropriate for providing optimum feed to the second wheel.

Furthermore, making the diffusing portion and the outlet portion as non-tubular parts that are secured to each other enables them to be arranged in such a manner as to be capable of ensuring mechanical integrity for the return channel that they define.

Conversely, the remaining portions of the return channels may be made out of tubes.

Thus, in an embodiment, for each of the return channels, the bend portion and/or the return portion of each of the channels is/are made out of one or more tubes. Making these portions of return channels out of tube(s) is a technique that is inexpensive, enabling a device to be made that is compact and of small total weight, and also providing good hydraulic performance. Furthermore, quality control is particularly simple to perform on the tube(s) forming the bend portion of each channel. The bend portion may be made out of a single tube, or indeed out of a set of tubes assembled together end-to-end.

Advantageously, making the bend portion out of one or more tubes enables this portion to present a surface state that is very smooth, which is preferable for ensuring very low head loss in this portion of the return channel.

The tube(s) from which the bend portion and/or the return portion are made may in particular present a section that is circular, oval, elliptical, or other, in particular at its inlet and/or is outlet, in order to satisfy hydraulic constraints. At least one of these tubes may be a thin-walled tube, i.e. it may have walls of thickness that is less than 10% of the inside diameter of the tube.

Also, the various improvements below may be applied to the invention, separately or in combination.

For each of the return channels:
the bend portion and the return portion may be formed from a single tubular part;
the return portion may be formed in a non-tubular part, referred to as the third non-tubular part; and optionally
this third tubular part may be the first non-tubular part (i.e. these two non-tubular parts may form a single part).

Advantageously, making the return portion out of a non-tubular part makes it easier to integrate the return channels mechanically and makes it easier to ensure structural integrity for the channels.

More generally, a non-tubular part may be used to make the return channels, in association with tubular parts, as follows:
in one embodiment, each of said channels has two tubular fractions formed in tubular parts, and a fourth non-tubular part is interposed between said tubular fractions. The tubular portions may in particular be formed in the bend portion and/or the return portion. The fourth non-tubular part serves to improve the mechanical strength of the device by providing the junction between the tubular fractions.

In an embodiment, for each of said channels, the fourth non-tubular part and said first non-tubular part are formed in a single non-tubular part.

The various properties of the diffusing portion, of the bend portion, of the return portion, and of the outlet portion are specified above respectively for each of the channels, independently of the other channels.

That said, it is naturally preferable to make the respective non-tubular parts of a plurality of return channels in grouped manner, so as to group together within a single part the respective non-tubular parts of a plurality of return channels.

This can be done for the various above-mentioned non-tubular parts, i.e. the first and/or second and/or third and/or fourth non-tubular parts (it also being understood that any two or three or four parts selected from the first, second, third, and fourth non-tubular parts may optionally be formed integrally so as to constitute a single part).

Thus, in an embodiment, the union of the first non-tubular parts and/or the union of the second non-tubular parts and/or the union of the third non-tubular parts and/or the union of the fourth non-tubular parts constitutes an assembly of one or more non-tubular parts forming a first axisymmetric body extending over 360° around the axis (A) of the device.

(In the above sentence, the first, second, third, and fourth non-tubular parts are considered in the plural, but more simply, the embodiment in question also includes the situation in which all of the first, second, third, and/or fourth non-tubular parts contributing to forming the set of return channels are formed integrally so that only one part constitutes the first, second, third, and/or non-tubular part for all of the return channels).

For example, in one embodiment, when the return portion is non-tubular, the diffusing portion and/or the return portion may be formed respectively in a “diffusion” part and in a “return” part, which, when united, together form a body extending over 360° around an axis of the device. The diffusion and/or return parts made in the manner specified above constitute structural parts of the device. Conversely, the bend portions of return channels between each diffusing portion and the return portion need not necessarily have any structural function within the machine, and they may be constituted by tubes. This embodiment imparts high mechanical strength to the device and facilitates assembly.

More generally, the invention also provides a turbomachine, e.g. a turbopump, including at least one fluid transfer device as defined above.

Furthermore, a second object of the invention is to define a method of fabricating a fluid transfer device as defined above, enabling return channels to be made in optimized manner, the device consequently presenting efficiency that is improved compared with known devices.

In order to make the device, the diffusing portions are formed by any one of the following technologies:
machining (where the term “machining” is used herein to cover only mechanical machining);
electro-erosion of a forged or cast blank, or of a blank obtained by powder metallurgy or by additive fabrication; and/or
direct forming using powder metallurgy, casting, or additive fabrication.

This step is found to be particularly effective for making the diffusing portions of the return channels by giving them a shape that is accurate and presenting good hydrodynamic performance.

The method also includes a step that is distinct from the above step, in which the bend portions of the return channels are formed.

In certain variants of this fabrication method, the return channels may comprise tubes. These tubes may be made by hydroforming, powder metallurgy, machine welding, casting, additive fabrication, or even bending, particularly if the return channel presents axes at the inlet and the outlet of the tube lie in the same plane.

The junction between the various adjacent parts from which the channels are formed (i.e. the parts lying in succession along the path of the fluid stream passing along the channels) may be made by brazing, welding, or the equivalent. By way of example, this may be the junction between the diffusing portions of the channels and the tubes containing the bend portions of the channels.

The invention can be well understood and its advantages appear better on reading the following detailed description of embodiments shown as nonlimiting examples. The description refers to the accompanying drawings, in which:

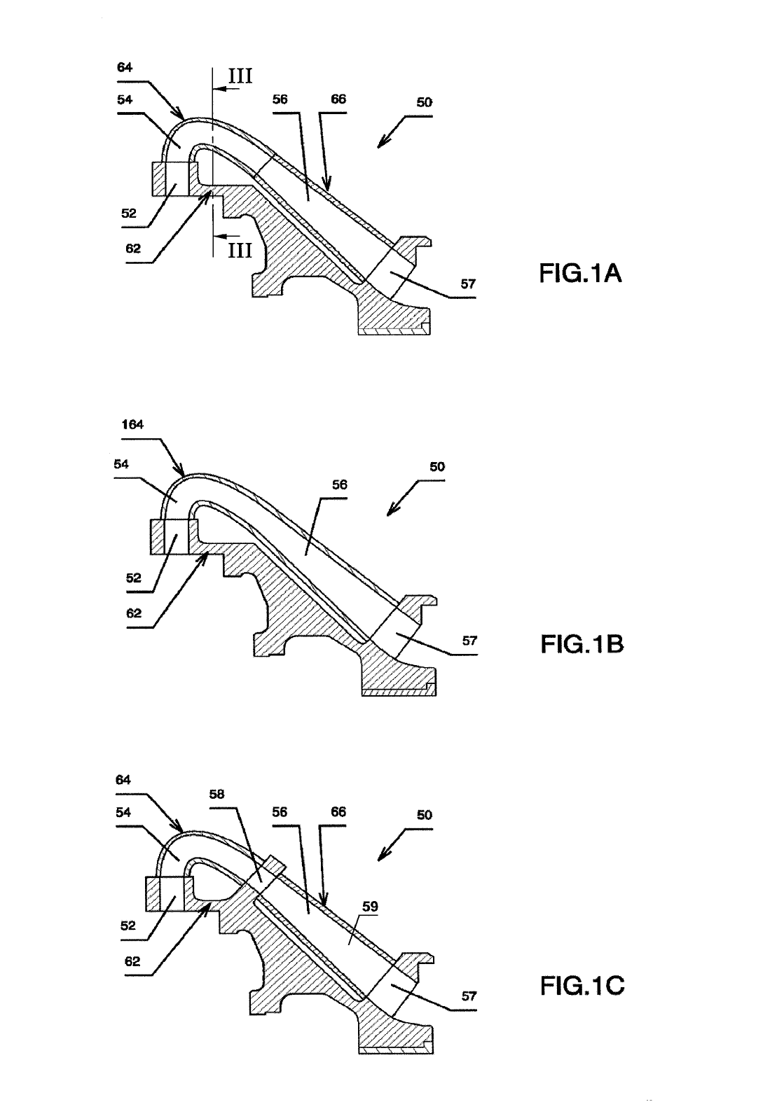

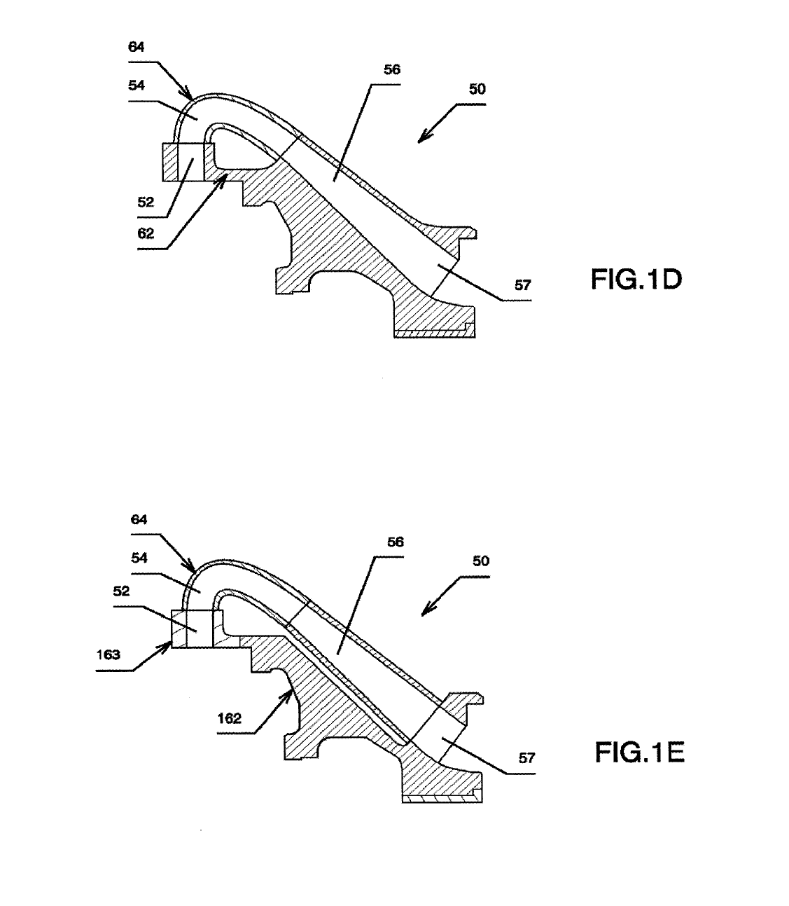

FIG. 1A is a detail section view of a return channel of a fluid transfer device constituting a first embodiment of the invention;

FIGS. 1B, 1C, 1D, and 1E are detail section views of four variants of a return channel for fluid transfer devices constituting second, third, fourth, and fifth embodiments of the invention;

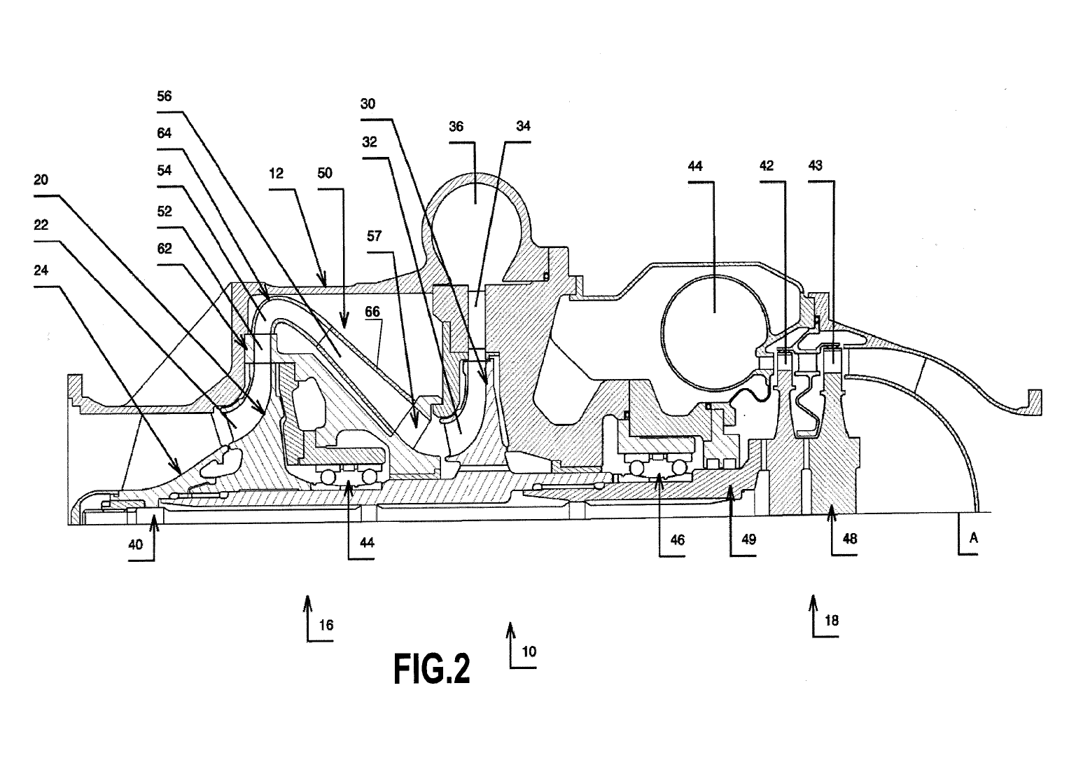

FIG. 2 is an axial half-section view of an example multistage high-power centrifugal turbopump fitted with a fluid transfer device in accordance with the invention, and including the return channels shown in FIG. 1A; and

FIG. 3 is a cross-section view of a transfer device in a sixth embodiment of the invention.

FIG. 2 shows a multistage turbopump 10 similar to various turbopumps used in cryogenic rocket engines known under the name Vulcain (registered trademark) and serving to feed such engines with liquid hydrogen at high pressure.

The turbopump 10 comprises a two-stage centrifugal pump 16 and a turbine 18 the drives the rotor of the pump 16 in rotation about an axis A.

The pump 16 constitutes a fluid transfer device in the meaning of the invention.

Inside a casing 12, the rotor of the pump 16 comprises a first centrifugal wheel 20 having blades 22, a second centrifugal wheel 30 having blades 32, an inducer 24, and a connection part 49.

The inducer 24, which imparts good suction characteristics and makes a high speed of rotation possible, is placed at the inlet of the pump 16 downstream from the duct (not shown) for admitting working fluid into the pump 16. The connection part 49 constrains the wheel 30 to rotate with the rotor of the turbine 18.

The inducer 24, the wheels 20 and 30, and the connection part 49 are stacked and clamped together axially by a tie bar or central shaft 40 of the pump 16.

The stator of the pump 16 includes the casing 12, and inside the casing, a set of fluid return channels 50. These channels pick up and slow down the fluid delivered by the wheel 20 and direct it towards the inlet of the wheel 30. The number of return channels may vary depending on the machine, and in general lies in the range 7 to 17.

In the pump 16, the working fluid is sucked in via the inducer 24; it is driven and compressed by the first bladed wheel 20; it is collected at the outlet from the wheel 20 by the fluid return channels 50. The working fluid is then driven and compressed once again by the second bladed wheel 30.

The fluid as compressed in this way is then collected at the outlet from the wheel 30 by a diffuser 34, which slows down the fluid before feeding the toroidal delivery duct 36.

The turbine 18 is arranged behind the second wheel 30 of the pump 16 (i.e. on the right-hand side of FIG. 2).

It comprises an admission torus 44 and a rotor mainly comprising two bladed turbine elements 42 and 43.

When the turbopump 10 is in operation, a stream of gas at high pressure penetrates into the turbine 18 via the torus 44 and passes in succession through the turbine elements 42 and 43, which it drives in rotation. Under the effect of the pressure exerted by the fluid on the turbine elements 42 and 43 as it passes through the turbine 18, these elements act via the connection part 49 to drive drive rotation of the the wheels 20 and 30 together with the inducer 24.

Thereafter, within the turbopump 10, the turbine portion 18 actuates the pump 16.

The main rotary portions of the machine, namely the inducer 24, the wheel 20, the wheel 30, the tie bar 40, and the turbine elements 42 and 43 are guided in rotation by rolling bearings 44 and 46. Relative to the axis A of the turbopump, the rolling bearing 44 is mounted between the wheel 20 and the wheel 30, and the rolling bearing 46 is mounted downstream from the wheel 30 in register with the connection part 49.

Inside the pump 16, and as mentioned above, reference 50 designates the various return channels that extend from the outlet of the first wheel 20 to the inlet of the second wheel 30.

These return channels are axisymmetric, i.e. each of them can be derived from the adjacent channel merely by turning about the axis A through an angle that depends on the total number of channels. For example, if the total number of channels is twelve, turning a channel about the axis A through 30° serves to obtain the adjacent channel.

Each of the return channels 58 presents four portions, namely a diffusing portion 52, a bend portion 54, a return portion 56, and an outlet portion 57.

The diffusing portions 52 are arranged within a non-tubular part 62 referred to as a “hub”, which provides the device with its structural integrity and its mechanical strength. This part 62 constitutes the second non-tubular part in the meaning of the invention, with this applying in like manner for all of the channels 50. Specifically, the part 62 is formed in integral or one-piece manner, and it extends over 360° about the axis A of the turbopump.

In a section containing the axis of rotation A of the device (FIG. 1A), the diffusing portions 52 extend in respective radial directions.

The outlet portion 57 of the channels are also arranged within the part 62, thereby limiting the number of parts in the turbomachine. The part 62 thus constitutes not only the second non-tubular part in the meaning invention, but also the first non-tubular part, and this applies to all of the channels 50.

Unlike the diffusing and outlet portions, the bend and return portions 54 and 56 of the return ducts 50 are formed by tubular parts that are distinct from the hub 62.

Each of the bend portions 54 is formed inside an independent tubular part 64. In the same manner, each of the return portions 56 is formed inside an independent tubular part 66.

It follows that the number of tubular parts 64, like a number of tubular parts 66, is equal to the total number of channels incorporated in the device 50. In a similar embodiment, the parts 64 and/or the parts 66 may be united to form a single part, extending over 360° around the axis A.

FIGS. 1B, 1C, 1D, and 1E show four other embodiments of the invention. They are identical to the first embodiment of the invention, apart from certain differences that are specified below. These differences lie in the way in which the various portions of the return channels 50 are made.

In these embodiments, parts that are identical or similar to the first embodiment are given the same numerical references.

In the second embodiment of the invention (FIG. 1B), the bend portion 54 and the return portion 56, instead of being formed as two distinct parts (tubes 64 and 66) as in FIG. 1A, are formed in a single tubular part 164. This variant makes it possible to be unaffected by potential problems at the connections between the tubular parts 64 and 66, as shown in FIG. 1A. In contrast, it can lead to greater difficulty in making the part 164 compared with parts 64 and 66 that are made separately.

In the third embodiment (FIG. 1C), a fraction 58 of the return portion 56 of each of the channels is formed in a non-tubular part (which constitutes a “fourth non-tubular part” in the above-defined meaning), arranged between two tubular parts or portions.

This fourth non-tubular part is constituted by the part 62 that also has formed therein, for each of the channels, the diffusing portion 52 and the outlet portion 57.

The return portion 56 is thus made up of two fractions:
an upstream fraction 58 formed in the part 62 and connected upstream to the outlet orifice from the bend portion 54 formed in a tube 64;
a downstream fraction 59 formed in a tube 66 connected upstream to the outlet orifice of the upstream fraction 58.

The advantage of this variant is to deal with potential problems at the connection between the tubular parts 64 and 66 as shown in FIG. 1A.

In the fourth embodiment (FIG. 1D), the return portion 56 is constituted by a third non-tubular part in the above-defined meaning. Like the diffusing portion 52 and the outlet portion 56, it is formed in the part 62. Under such circumstances, the return portion 56 is formed integrally (as a single piece) with the outlet portion 57, within the part 62. Although this variant may lead to the return portion and the outlet portion possibly being more complex to make (e.g. by machining or by electro-erosion), it makes it possible, conversely, to avoid or at least limit potential problems with connections between the tubular parts 64 and 66 as shown in FIG. 1A.

In all of the above described embodiments, it is possible in a similar embodiment for the first non-tubular part in which the outlet portion is formed, and the tubular part in which the diffusing portion is formed to be made as distinct parts, that are secured to each other. The part 62 shown in FIGS. 1A to 1D is then replaced by at least two parts.

The fifth embodiment (FIG. 1E) illustrates this possibility. In this embodiment, the first tubular portion is formed by a first non-tubular part 162. The second tubular part is formed by a second non-tubular part 163 that is rigidly fastened to the part 162 by means that are not shown, e.g. by welding.

In all of the above described embodiments, the tubes 64, 66, and 164 are thin-walled tubes.

Finally, FIG. 3 shows a sixth embodiment presenting a possible arrangement, in particular for the non-tubular parts.

This arrangement is shown for the second non-tubular part, but it could equally well be applied to one or more of the first, third, and fourth non-tubular parts.

The sixth embodiment is identical to the first embodiment (FIG. 1A) apart from the following difference.

In the first embodiment, the part 62 extends over 360° around the axis A; the diffusing (and outlet) portions of all of the channels are formed in the part 62.

Nevertheless, the part 62 may be subdivided into a plurality of distinct fractions that are arranged in axisymmetric manner around the axis A: for example four fractions, each occupying an angular sector of 90° around the axis.

This embodiment is shown in FIG. 3. It represents a cross-section of the transfer device perpendicularly to the axis A, axially level with the bend portion 54.

In this embodiment, the device comprises four distinct parts 62A, 62B, 62C, and 62D, all having the same shape. These parts are assembled around the axis A, each occupying a quadrant so as to form an axisymmetric body.

The axisymmetric body has the same shape and the same function as the parts 62 shown in FIG. 1A but it is made up of four parts 62A, 62B, 62C, and 62D instead of being formed by a single part; it has the same reference 62 as the part 62.

1-12. (canceled)

13. A fluid transfer device comprising a rotor having at least a first centrifugal wheel and a second centrifugal wheel, and a stator incorporating a plurality of return channels;
in which device the return channels are axisymmetric, and each return channel includes in succession along the fluid flow path from the first wheel:
a diffusing portion suitable for guiding the fluid stream in a centrifugal flow direction; then
a bend portion suitable for redirecting the fluid stream in a centripetal flow direction; then
a return portion suitable for guiding the fluid along a centripetal path; and then
an outlet portion formed in a first non-tubular part, and suitable for guiding the fluid towards the inlet of the second centrifugal wheel;
wherein each of said return channels is suitable for collecting a portion of a fluid stream leaving the first wheel and for directing this stream portion to an inlet of the second wheel without exchanging the fluid with any other one of said return channels; and in that for each of said channels:
the diffusing portion and the bend portion are formed in distinct parts; and
the diffusing portion is formed in a second non-tubular part secured to the first non-tubular part.

14. The device according to claim 13, wherein for each of said channels, the bend portion and/or the return portion is/are formed in one or more tubes.

15. The device according to claim 14, wherein for each of said channels, the bend portion and the return portion are formed in a single tubular part.

16. The device according to claim 13, wherein for each of said channels, the return portion is formed in a third non-tubular part

17. The device according to claim 16, wherein for each of said channels, the third non-tubular part and said first non-tubular part are formed in a single non-tubular part.

18. The device according to claim 16, wherein a union of said third non-tubular parts constitutes an assembly of one or more non-tubular parts forming an axisymmetric body extending over 360° around an axis of the device.

19. The device according to claim 17, wherein a union of said third non-tubular parts constitutes an assembly of one or more non-tubular parts forming an axisymmetric body extending over 360° around an axis of the device.

20. The device according to claim 13, wherein each of said channels has two tubular fractions formed in tubular parts, and a fourth non-tubular part is interposed between said tubular fractions.

21. The device according to claim 20, wherein for each of said channels, the fourth non-tubular part and said first non-tubular part are formed in a single non-tubular part.

22. The device according to claim 20, wherein a union of said fourth non-tubular parts constitutes an assembly of one or more non-tubular parts forming an axisymmetric body extending over 360° around an axis of the device.

23. The device according to claim 21, wherein a union of said fourth non-tubular parts constitutes an assembly of one or more non-tubular parts forming an axisymmetric body extending over 360° around an axis of the device.

24. The device according to claim 13, wherein a union of said first non-tubular parts and/or a union of said second non-tubular parts constitutes an assembly of one or more non-tubular parts forming an axisymmetric body extending over 360° around an axis of the device.

25. The turbomachine including at least one device according to claim 13.

26. The method of fabricating a fluid transfer device according to claim 13, wherein said diffusing portions are formed by any one of the following technologies:
machining;
electro-erosion of a forged or cast blank, or of a blank obtained by powder metallurgy or by additive fabrication; and/or
direct forming using powder metallurgy, casting, or additive fabrication.
